(19) United States
(12) Patent Application Publication
(10) Pub. No.: US 2016/0019569 A1
(43) Pub. Date: Jan. 21, 2016

(54) SYSTEM AND METHOD FOR SPEECH CAPTURE AND ANALYSIS

(71) Applicant: SPEETRA, INC., Dallas, TX (US)

(72) Inventors: Pawan Jaggi, Plano, TX (US); Abhijeet Sangwan, Allen, TX (US)

(73) Assignee: SPEETRA, INC., Dallas, TX (US)

(21) Appl. No.: 14/335,214

(22) Filed: Jul. 18, 2014

(51) Int. Cl. G06Q 30/02; G06F 17/27

(52) U.S. Cl. CPC G06Q 30/0203; G06F 17/2785

(57) ABSTRACT

A system and method for determining a survey sentiment includes a network, a survey system, an administrator, and a set of users, each connected to the network. The method includes the steps of receiving a set of questions for the survey, a set of predetermined answers to the set of questions, a set of parameters, and a target list, generating a survey message from the target list and the set of parameters, sending the survey message, sending the set of questions and the set of predetermined answers in response to the survey message, receiving a set of audio responses and a set of text responses to the set of questions, receiving a set of selected answers to the set of questions, determining a set of sentiments from the set of audio responses, the set of text responses, and the set of selected answers, and compiling the set of sentiments.

### FIELD OF THE INVENTION

The present invention relates to systems and methods for speech recognition. In particular, the present invention relates to a system and method for capturing and analyzing speech to determine emotion and sentiment.

### BACKGROUND OF THE INVENTION

Statistical surveys are undertaken for making statistical inferences about the population being studied. Surveys provide important information for many kinds of public information and research fields, e.g., marketing research, psychology, health professionals, and sociology. A single survey typically includes a sample population, a method of data collection and individual questions the answers to which become data that are statistically analyzed. A single survey focuses on different types of topics such as preferences, opinions, behavior, or factual information, depending on its purpose. Since survey research is usually based on a sample of the population, the success of the research is dependent on the representativeness of the sample with respect to a target population of interest to the researcher. That target population ranges from the general population of a given country to specific groups of people within that country, to a membership list of a professional organization, or a list of customers who purchased products from a manufacturer.

Further, the reliability of these surveys strongly depends on the survey questions used. Usually, a survey consists of a number of questions that the respondent has to answer in a set format. A distinction is made between open-ended and closed-ended questions. An open-ended question asks the respondent to formulate his or her own answer, whereas a closed-ended question has the respondent pick an answer from a given number of options. The response options for a closed-ended question should be exhaustive and mutually exclusive. Four types of response scales for closed-ended questions are distinguished: dichotomous, where the respondent has two options; nominal-polytomous, where the respondent has more than two unordered options; ordinal-polytomous, where the respondent has more than two ordered options; and bounded continuous, where the respondent is presented with a continuous scale. A respondent's answer to an open-ended question can be coded into a response scale afterwards, or analyzed using more qualitative methods.

There are several ways of administering a survey. Within a survey, different methods can be used for different parts. For example, interviewer administration can be used for general topics but self-administration for sensitive topics. The choice between administration modes is influenced by several factors, including costs, coverage of the target population, flexibility of asking questions, respondents' willingness to participate, and response accuracy. Different methods create mode effects that change how respondents answer.

Recently, most market research companies in the United States have developed online panels to recruit participants and gather information. Utilizing the Internet, thousands of respondents can be contacted instantly rather than the weeks and months it used to take to conduct interviews through telecommunication and/or mail. By conducting research online, a research company can reach out to demographics they may not have had access to when using other methods. Big-brand companies from around the world pay millions of dollars to research companies for public opinions and product reviews by using these free online surveys. The completed surveys attempt to directly influence the development of products and services from top companies.

Online surveys are becoming an essential research tool for a variety of research fields, including marketing, social, and official statistics research. According to the European Society for Opinion and Market Research (“ESOMAR”), online survey research accounted for 20% of global data-collection expenditure in 2006. They offer capabilities beyond those available for any other type of self-administered questionnaire. Online consumer panels are also used extensively for carrying out surveys. However, the quality of the surveys conducted by these panels is considered inferior because the panelists are regular contributors and tend to be fatigued.

Further, online survey response rates are generally low and also vary extremely—from less than 1% in enterprise surveys with e-mail invitations to almost 100% in specific membership surveys. In addition to refusing participation, terminating surveying during the process or not answering certain questions, several other non-response patterns can be observed in online surveys, such as lurking respondents and a combination of partial and question non-responsiveness.

Therefore, there is a need in the art for a system and method for capturing and analyzing speech to determine emotion and sentiment from a survey.

### SUMMARY

A system and method for determining a sentiment from a survey is disclosed. The system includes a network, a survey system connected to the network, an administrator connected to the network, and a set of users connected to the network. The method includes the steps of receiving a set of questions for the survey, a set of predetermined answers to the set of questions, a set of parameters, and a target list, generating a survey message from the target list and the set of parameters, sending the survey message to the set of users, sending the set of questions and the set of predetermined answers in response to the survey message, receiving a set of audio responses to the set of questions, receiving a set of text responses to the set of questions, receiving a set of selected answers to the set of questions, determining a set of sentiments from the set of audio responses, the set of text responses, and the set of selected answers, and compiling the set of sentiments. A report is generated from the compiled set of sentiments and sent to the administrator for analysis.

### BRIEF DESCRIPTION OF THE DRAWINGS

In the detailed description of the preferred embodiments presented below, reference is made to the accompanying drawings.

FIG. 1 is a schematic of the system of a preferred embodiment.

FIG. 2 is flowchart of a method for delivering and analyzing a survey of a preferred embodiment.

FIG. 3A is flowchart of a method for analyzing a set of audio responses to a survey of a preferred embodiment.

FIG. 3B is flowchart of a method for determining speech sentiment of a preferred embodiment.

FIG. 4A is flowchart of a method for analyzing a set of text responses to a survey of a preferred embodiment.

FIG. 4B is a flowchart of a method for determining a written sentiment of a preferred embodiment.

FIG. 5 is flowchart of a method for compiling survey results of a preferred embodiment.

### DETAILED DESCRIPTION

It will be appreciated by those skilled in the art that aspects of the present disclosure may be illustrated and described in any of a number of patentable classes or contexts including any new and useful process or machine or any new and useful improvement. Aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Further, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. For example, a computer readable storage medium may be, but not limited to, an electronic, magnetic, optical, electromagnetic, or semiconductor system, apparatus, or device, or any suitable combination of the foregoing. More specific examples of the computer readable storage medium would include, but are not limited to: a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. Thus, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. The propagated data signal may take any of a variety of forms, including, but not limited to, electro-magnetic, optical, or any suitable combination of them. A computer readable signal medium may be any computer readable medium that is not a computer readable storage medium and that can communicate, propagate, or transport a program for use by or in connection with an instruction execution system, apparatus, or device.

Computer program code for carrying out operations for aspects of the present disclosure may be written in any combination of one or more programming languages, including an object oriented programming language such as Java, C++, C#, .NET, Objective C, Ruby, Python SQL, or other modern and commercially available programming languages.

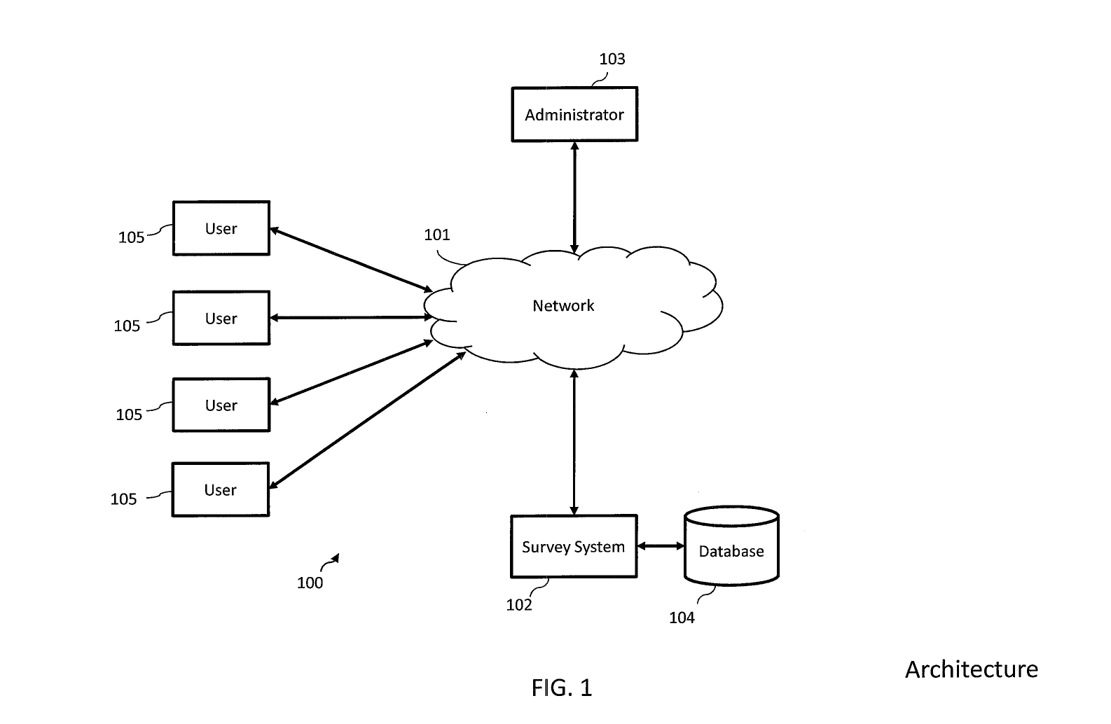

Referring to FIG. 1, system 100 includes network 101, survey system 102 connected to network 101, administrator 103 connected to network 101, and set of users 105 connected to 101.

In a preferred embodiment, network 101 is the Internet. Survey system 102 is further connected to database 104 to communicate with and store relevant data to database 104. Users 105 are connected to network 101 by communication devices such as smartphones, PCs, laptops, or tablet computers. Administrator 103 is also connected to network 101 by communication devices.

In one embodiment, user 105 communicates through a native application on the communication device. In another embodiment, user 105 communicates through a web browser on the communication device.

In a preferred embodiment, survey system 102 is a server.

In a preferred embodiment, administrator 103 is a merchant selling a good or service. In this embodiment, user 105 is a consumer who purchased the good or service from administrator 103. In another embodiment, administrator 103 is an advertising agency conducting consumer surveys on behalf of a merchant.

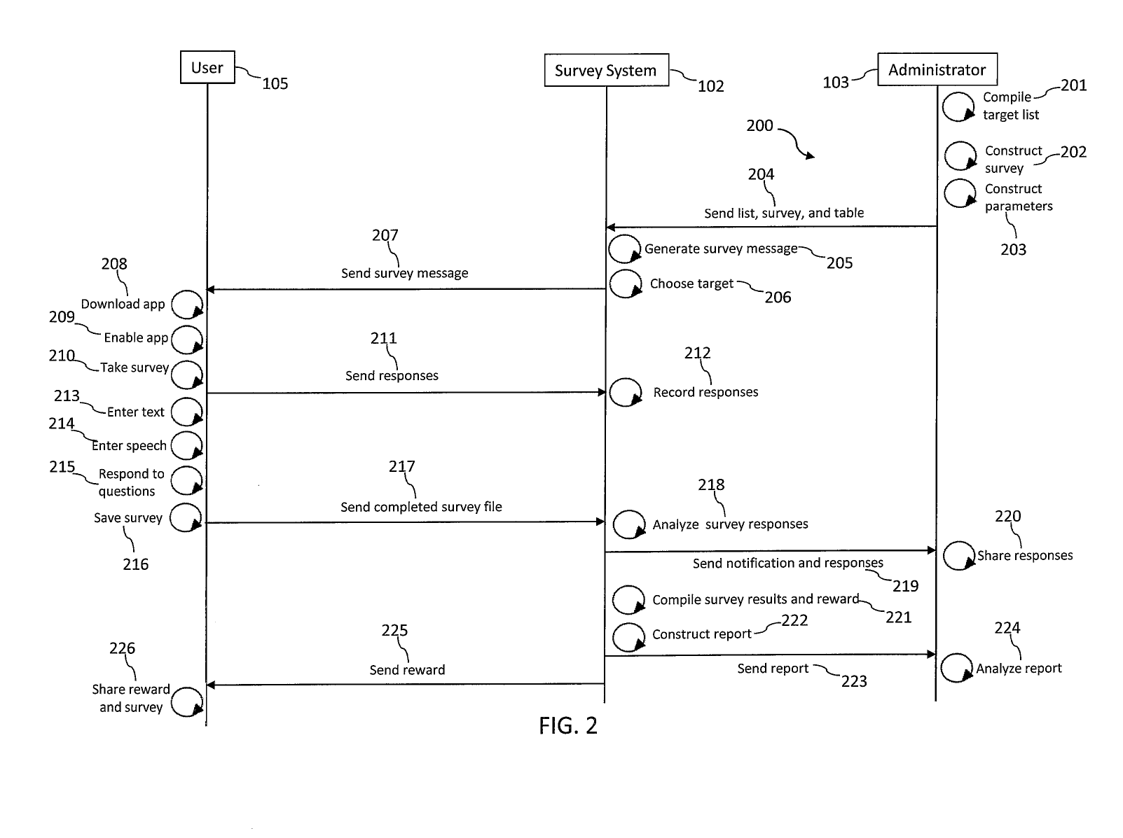

Referring to FIG. 2, method 200 for generating and distributing surveys is described. In step 201, administrator 103 compiles a list of users 105 to target to receive a survey. In one embodiment, the list includes customers who have submitted their contact information by purchasing a product. In this embodiment, the list is generated from a point of sales (PoS) system. In another embodiment, the list is produced from contact information obtained from e-mail accounts such as Gmail, from social media, or any web application. In this embodiment, the list is retrieved through application program interfaces (APIs) of any web application or enterprise database.

In step 202, administrator 103 constructs a survey by drafting a list of questions and a set of predetermined answers to the list of questions. In one embodiment, the list of questions is displayed as text.

In another embodiment, the list of questions is recorded and presented in audio. In one embodiment, the recorded audio questions are presented to the user in a telephone call, as will be further described below.

In another embodiment, a digital avatar is used to present the list of questions via animation. In this embodiment, administrator 103 records the survey in audio format and the digital avatar “speaks” the recorded audio when presented to a user.

In a preferred embodiment, each predetermined answer of the set of predetermined answers corresponds to a sentiment. For example, each survey question includes five predetermined answers, each listing a sentiment: very unsatisfied, unsatisfied, somewhat satisfied, satisfied, and very satisfied. In one embodiment, the set of predetermined answers are selected using a set of radio buttons. In this embodiment, each radio button lists a sentiment. In another embodiment, the set of predetermined answers are selected using a set of graphical emoticons. In this embodiment, each emoticon corresponds to a sentiment. Any means of selection may be employed.

In step 203, administrator 103 constructs a set of parameters for the survey. In this step, the set of parameters includes a set of desired demographics of the targeted users that will receive the survey and a set of filter criteria by which the survey is to be filtered. The set of parameters includes a subset of questions that may be asked depending on the time, location, language, and demographics of the user. The set of parameters further includes a set of topical keywords and phrases related to a specific industry or business vocabulary. For example, in a survey regarding social networks the words “tweet” or “selfie” are included for comparison to a user's response.

The set of parameters further includes a reward sent to a user based on a set of reward criteria that the user must meet in order to receive the reward. The set of reward criteria includes a predetermined number of questions that must be answered or a predetermined response to a question or set of questions. For example, the reward is an electronic gift card, a voucher to be redeemed at a point of sale, or a good to be shipped to the user.

In one embodiment, the set of parameters includes a set of weights for determining the reward as will be further described below.

The set of parameters further includes any recommended comments that the administrator desires to be included in a report. For example, the set of recommended comments includes survey responses having only positive, negative, or neutral sentiments.

The set of parameters includes a set of notifications that administrator 103 receives. The set of notifications will notify administrator 103 when survey system 102 receives a positive, a negative, and/or a neutral response.

In step 204, the target list, survey, and set of parameters are sent to survey system 102 and saved into database 104.

In step 205, a survey message is generated. In step 206, survey system 102 selects a target user according to the target list and the set of parameters. In step 207, a survey message is sent to each user 105. In a preferred embodiment, the survey message is a link sent via a text message, an instant message, an email message, or a social media message, such as Facebook, Twitter, and Google Plus. In one embodiment, the survey message is sent via mobile push notification. Any electronic message may be employed.

In step 208, user 105 downloads a survey app after selecting the link. It will be appreciated by those skilled in the art that the survey app is not required in that a web application may be employed to take the survey. In this step, user 105 registers an account with survey system 102 by entering contact and demographic information including a name, age, language, and an email address. In step 209, user 105 enables the survey app. In one embodiment, user 105 selects a logo of the survey app. In another embodiment, user 105 scans a bar code or a QR code to enable the survey app. In another embodiment, user 105 scans an NFC tag or an RFID tag to enable the survey app.

In step 210, user 105 initiates the survey using the survey app by selecting a button to take the survey. In this step, the survey app downloads the survey and saves the location, time, and communication device information including device model number, operating system type, and web browser type and version into a survey file. In one embodiment, the location is automatically determined by GPS on the user communication device. Other means of automatically detecting the location of the user communication device may be employed.

In one embodiment, the survey app initiates a telephone call via the user communication device to take the survey. In this embodiment, the list of questions is presented to user 105 over the telephone call and a set of audio responses are recorded using an interactive voice response (IVR) system. In step 211 in this embodiment, the set of audio responses is sent to survey system 102 via telephone. In step 212 in this embodiment, the survey system 102 records the set of audio responses.

In step 213, user 105 enters text as a response to a survey question using a keyboard. In step 214, user 105 enters voice audio as a response to a survey question. In this step, user 150 selects a button to initiate and stop voice recording. The survey app turns on and off the device microphone to capture audio responses.

In step 215, user 105 responds to a survey question by selecting a predetermined answer of the set of predetermined answers. In step 216, the completed survey and the entered responses are saved in the survey file. In step 217, the survey file is sent to survey system 102. In step 218, the survey responses are analyzed, as will be further described below as methods 300 and 400. In step 219, any notifications and responses requested by administrator 103 in the set of parameters are sent to administrator 103.

In step 220, administrator 103 shares the responses by electronic messages such as email, text message, and social media such as Facebook, Twitter, and LinkedIn. Any electronic message may be employed.

In step 221, the survey results and a reward are compiled, as will be further described below. In step 222, a report of the survey results is generated. The report includes a set of recommended comments based on the set of parameters. The set of recommended comments may include survey responses that included the strongest sentiment of positive, negative, or neutral sentiments. In step 223, the report is sent to administrator 103. In step 224, the report is analyzed. In this step, administrator 103 takes corrective action in response to any negative responses. In step 225, the reward is sent to user 105. In step 226, the reward may be shared on social media to entice other users to take part in the survey.

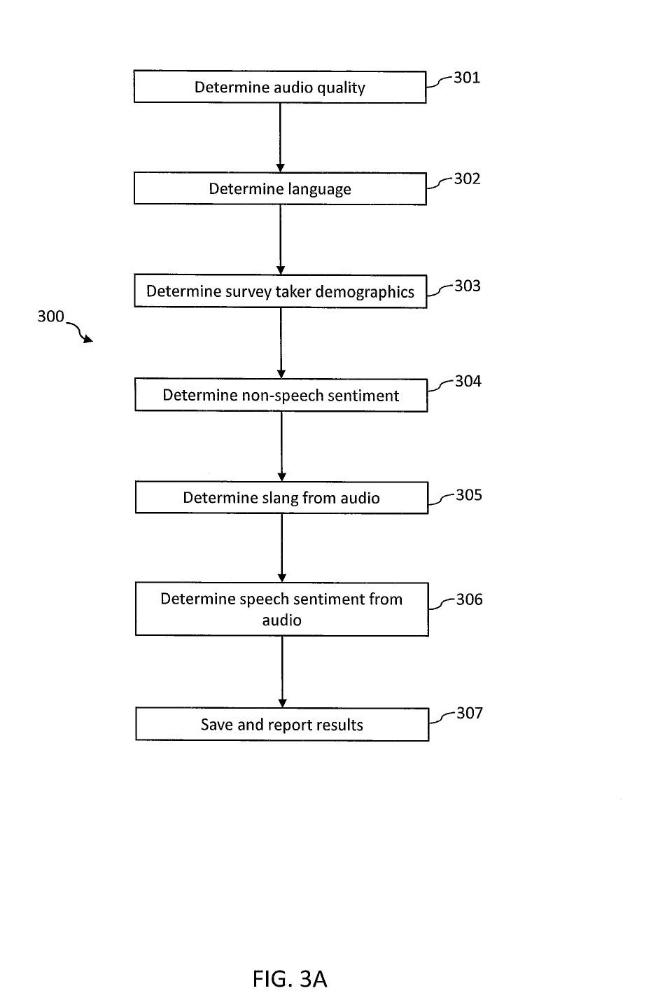

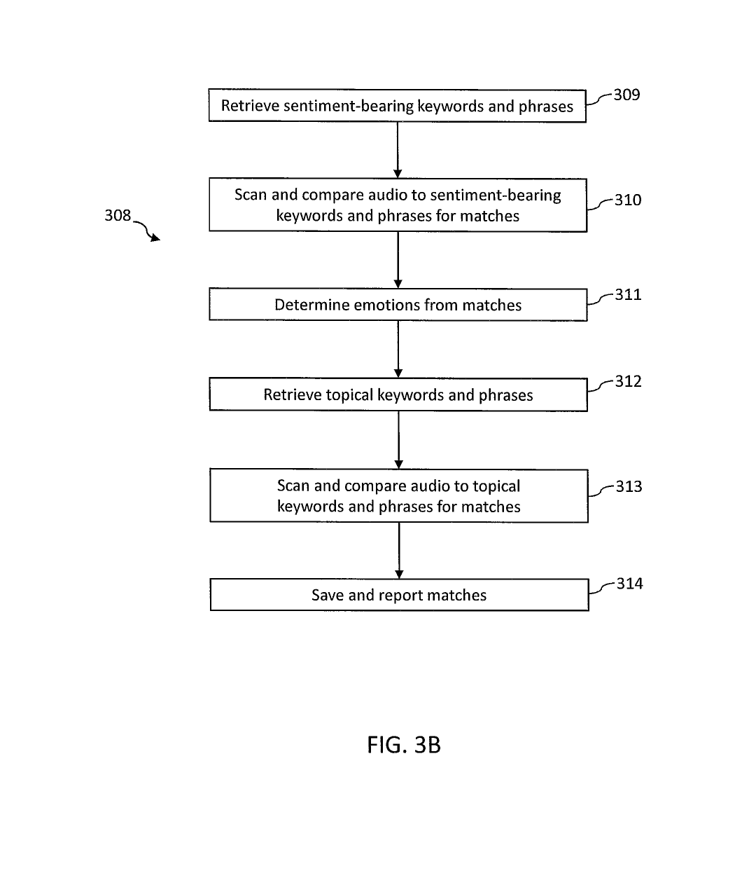

Referring to FIG. 3A, step 218 is further described as method 300 for analyzing a set of audio responses. In step 301, the audio quality of the set of audio responses is determined. In this step, a signal to noise ratio is computed. If the signal to noise ratio is greater than a predetermined ratio, then method 300 continues. In step 302, a language of the set of audio responses is determined. In one embodiment, the language is determined from the language of the survey questions.

In step 303, the demographics of the user are determined. In this step, the demographics are retrieved from the user's account registration in the database. In step 304, a non-speech sentiment is determined from each audio response. In this step, the pitch, tone, inflections, of each audio response is determined by examining the audio file for any sudden changes in frequency greater than a predetermined range of frequencies. In step 305, any slang used in the set of audio responses is determined. In this step, a set of slang words and phrases, including profanity, are retrieved from a database. Each of the set of slang words and phrases is an audio fingerprint. Each audio fingerprint is a condensed acoustic summary that is deterministically generated from an audio signal of the word or phrase. The set of audio responses is scanned and compared to the set of slang words and phrases for any matches.

In step 306, a speech sentiment is determined from the set of audio responses, as will be further described below. In step 307, the demographics, non-speech sentiment, slang, and speech sentiment, are saved for later reporting.

Referring to FIG. 3B, step 306 is further described as method 308. In step 309, a set of sentiment-bearing keywords and phrases is retrieved from a database. Each keyword or phrase includes a corresponding emotion. Each of the set of sentiment-bearing keywords and phrases is an audio fingerprint. In step 310, the set of audio responses is scanned and compared to the set of sentiment-bearing keywords and phrases for any matches. In step 311, any emotions are determined from the set of matches. The corresponding emotion of each matched keyword or phrase is summed according to each emotion. For example, a total of happy matched keywords or phrases, a total of sad matched keywords or phrases, and a total of angry matched keywords or phrases are calculated. In one embodiment, if any of the totals is a greater than a predetermined number, then that total is saved. In another embodiment, each total is ranked. The ranked totals are saved. In another embodiment, each emotion has a corresponding weight. In this embodiment, the weights of each emotion are summed and the weight totals are ranked.

In step 312, a set of topical keywords and phrases are retrieved from the database. Each of the set of topical keywords and phrases is an audio finger print. In step 313, the set of audio responses is scanned and compared to the set of topical keywords and phrases for any matches. In step 314, the set of sentiment matches and the set of topical matches are saved for later reporting.

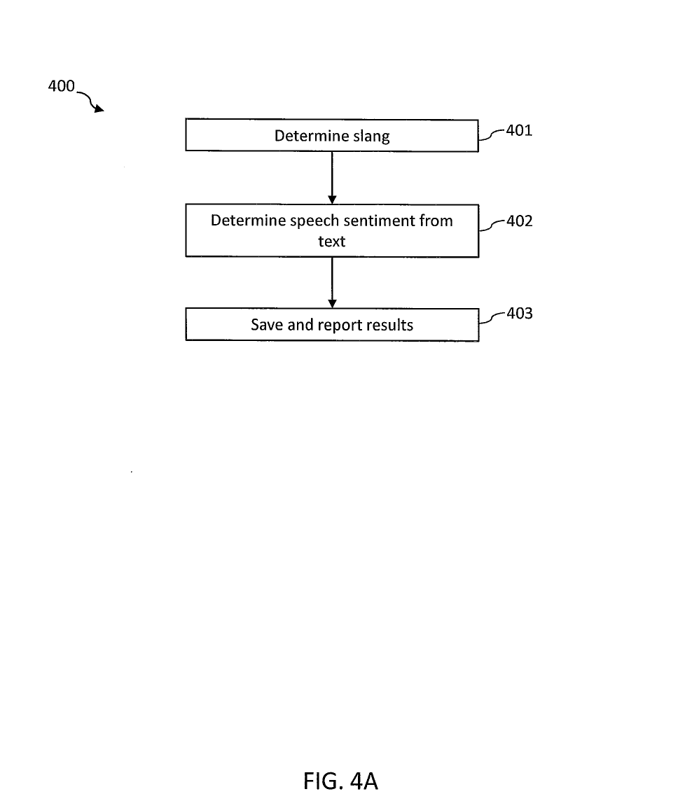

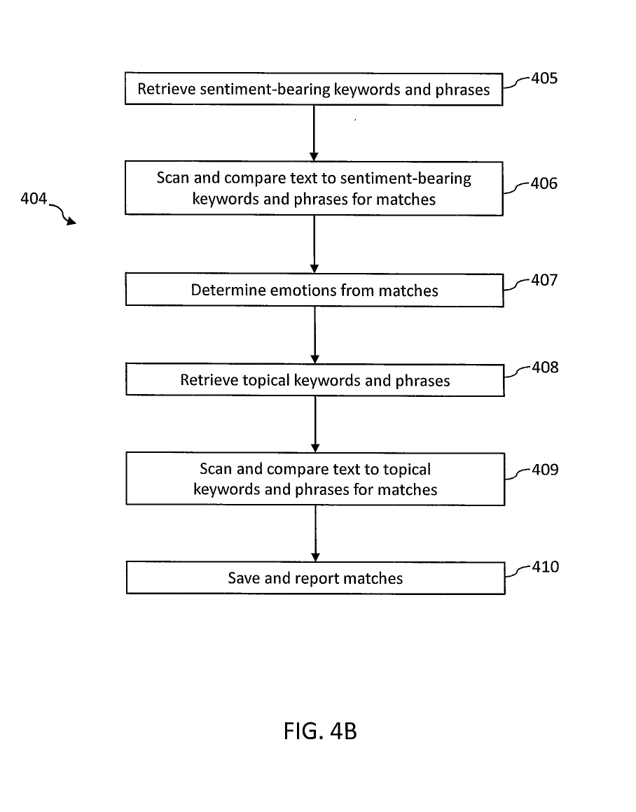

Referring to FIG. 4A, step 218 is further described as method 400 for analyzing text responses. In step 401, any slang used in the set of text responses is determined. In this step, a set of slang words and phrases, including profanity, are retrieved from a database. The set of text responses is scanned and compared to the set of slang words and phrases for any matches. In step 402, a text sentiment is determined from the set of text responses, as will be further described below. In step 403, the demographics, non-speech sentiment, slang, and text sentiment are saved for later reporting.

Referring to FIG. 4B, step 402 is further described as method 404. In step 405, a set of sentiment-bearing keywords and phrases is retrieved from a database. Each keyword or phrase includes a corresponding emotion. In step 406, the set of text responses is scanned and compared to the set of sentiment-bearing keywords and phrases for any matches. In step 407, any emotions are determined from the set of matches. The corresponding emotion of each matched keyword or phrase is summed according to each emotion. In one embodiment, if any of the totals is a greater than a predetermined number, then that total is saved. In another embodiment, each total is ranked. The ranked totals are saved. In another embodiment, each emotion has a corresponding weight. In this embodiment, the weights of each emotion are summed and the weight totals are ranked.

In step 408, a set of topical keywords and phrases are retrieved from the database. In step 409, the text responses are scanned and compared to the set of topical keywords and phrases for any matches. In step 410, the set of sentiment matches and the set of topical matches are saved for later reporting.

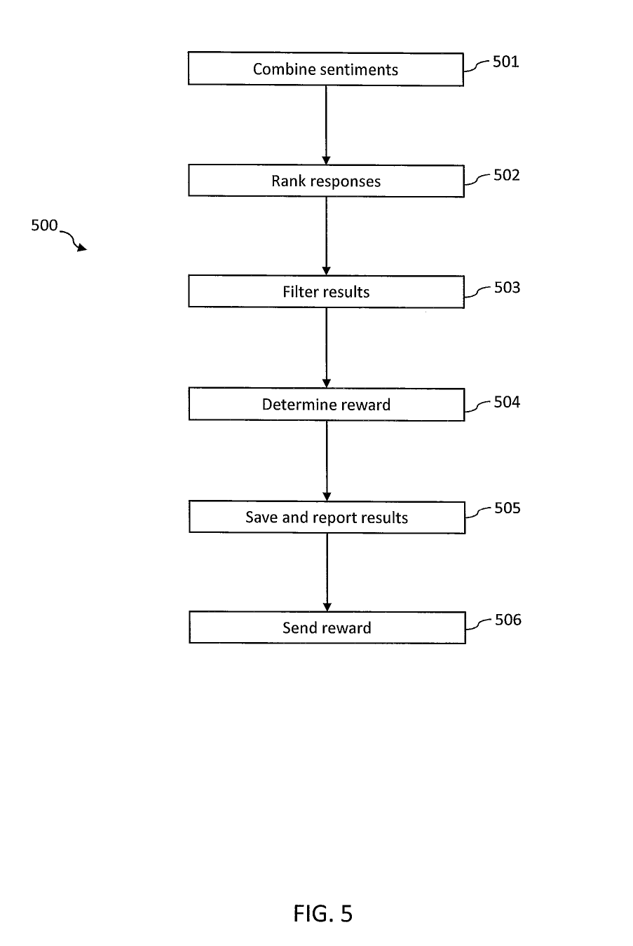

Referring to FIG. 5, step 221 is further described as method 500. In step 501, the set of audio responses, the set of text responses, and the set of selected predetermined answers are combined into a set of combined responses for the survey. The set of combined responses include any topical matches and sentiment matches.

In step 502, the set of combined responses is ranked based on criteria pre-selected by the administrator. In this step, the set of combined responses may be ranked based on sentiment. In step 503, the set of combined responses are filtered. In this step, the set of responses are filtered according to the set of parameters selected by the administrator. For example, the survey responses may be filtered according to gender, age, location, language, or user communication device type. The set of combined responses may be further filtered to filter out responses having poor audio quality, using profanity or responses with positive, neutral, or negative responses.

In step 504, a reward is determined for the user. In this step, the reward is determined from the set of combined responses. For example, if the user submitted a number of positive responses that exceed a predetermined number of positive responses, then the user receives the reward. In another example, if the user completed the survey, then the user receives the reward. If the user does not meet the criteria, then no reward is sent. In one embodiment, a weight is assigned to each of the set of matched sentiment-bearing keywords or phrases and/or the set of matched topical keywords. The set of weights are summed and if the total of summed weights is greater than a predetermined total, then a reward is sent. If the total of summed weights is less than the predetermined total, then a reward is not sent.

In step 505, the filtered combined responses including any topical matches are saved and reported to the administrator. In step 506, the reward is sent to the user, if the user has met the predetermined criteria.

It will be appreciated by those skilled in the art that modifications can be made to the embodiments disclosed and remain within the inventive concept. Therefore, this invention is not limited to the specific embodiments disclosed, but is intended to cover changes within the scope and spirit of the claims.

1. In a system for detecting a set of sentiments from a survey comprising a network, a survey system connected to the network, an administrator connected to the network, and a set of users connected to the network, the survey system programmed to store and execute instructions that cause the system to perform a method comprising the steps of:
receiving a set of questions for the survey, a set of predetermined answers, a set of parameters, and a target list;
generating a survey message from the target list and the set of parameters;
sending the survey message to each user of the set of users;
sending the set of questions and the set of predetermined answers in response to the survey message;
receiving a set of audio responses to the set of questions;
receiving a set of text responses to the set of questions;
receiving a set of selected answers from the set of predetermined answers;
determining the set of sentiments from the set of audio responses, the set of text responses, and the set of selected answers; and,
compiling the set of sentiments.

2. The method of claim 1, further comprising the step of generating a report from the set of sentiments.

3. The method of claim 1, wherein the step of determining the set of sentiments further comprises the steps of:
determining an audio quality from the set of audio responses;
determining a language from the set of audio responses;
determining a set of demographics from the set of audio responses;
determining a non-speech sentiment from the set of audio responses;
determining a set of slang phrases from the set of audio responses; and,
determining a speech sentiment from the set of audio responses.

4. The method of claim 3, wherein the step of determining a speech sentiment further comprises the steps of:
retrieving a set of audio sentiment keywords and phrases;
comparing the set of audio responses to the set of audio sentiment keywords and phrases to generate a set of audio sentiment matches;
determining a set of audio emotions from the set of audio sentiment matches;
retrieving a set of audio topical keywords and phrases; and,
comparing to the set of audio topical keywords and phrases to the set of audio responses to generate a set of audio topical matches.

5. The method of claim 4, wherein the step of determining the set of sentiments further comprises the steps of:
determining a set of text slang phrases from the set of text responses; and,
determining a set of text sentiments from set of text responses.

6. The method of claim 5, wherein the step of determining a set of text sentiments further comprises the steps of:
retrieving a set of text sentiment keywords and phrases;
comparing the set of text responses to the set of text sentiment keywords and phrases to generate a set of text sentiment matches;
determining a set of text emotions from the set of text sentiment matches;
retrieving a set of text topical keywords and phrases; and,
comparing the set of text topical keywords and phrases to the set of text responses to generate a set of text topical matches.

7. The method of claim 6, wherein the step of compiling the set of sentiments further comprises the steps of:
generating a set of combined responses from the set of audio sentiments, the set of text sentiments, and the set of selected answers;
ranking the set of combined responses;
filtering the set of combined responses;
determining a reward from the set of combined responses; and,
sending the reward to each user of the set of users.

8. In a system for detecting a set of combined sentiments from a survey comprising a network, a survey system connected to the network, an administrator connected to the network, and a set of users connected to the network, the survey system programmed to store and execute instructions that cause the system to perform a method comprising the steps of:
receiving a set of questions for the survey, a set of predetermined answers, a set of parameters, and a target list;
generating a survey message from the target list and the set of parameters;
sending the survey message to each user of the set of users;
sending the set of questions and the set of predetermined answers in response to the survey message;
receiving a set of audio responses to the set of questions;
receiving a set of text responses to the set of questions;
receiving a set of selected answers from the set of predetermined answers;
determining a set of audio sentiments from the set of audio responses;
determining a set of text sentiments form the set of text responses;
generating the set of combined sentiments from the set of audio sentiments, the set of text sentiments, and the set of selected answers; and,
compiling the set of combined sentiments.

9. The method of claim 8, further comprising the step of generating a report from the set of sentiments.

10. The method of claim 8, wherein the step of determining a set of audio sentiments further comprises the steps of:
determining an audio quality from the set of audio responses;
determining a language from the set of audio responses;
determining a set of demographics from the set of audio responses;
determining a non-speech sentiment from the set of audio responses;
determining a set of slang phrases from the set of audio responses; and,
determining a speech sentiment from the set of audio responses.

11. The method of claim 10, wherein the step of determining a speech sentiment further comprises the steps of:
retrieving a set of audio sentiment keywords and phrases;
comparing the set of audio responses to the set of audio sentiment keywords and phrases to generate a set of audio sentiment matches;
determining a set of audio emotions from the set of audio sentiment matches;
retrieving a set of audio topical keywords and phrases; and,
comparing to the set of audio topical keywords and phrases to the set of audio responses to generate a set of audio topical matches.

12. The method of claim 8, wherein the step of determining a set of text sentiments further comprises the steps of:
determining a set of text slang phrases from the set of text responses;
retrieving a set of text sentiment keywords and phrases;
comparing the set of text responses to the set of text sentiment keywords and phrases to generate a set of text sentiment matches;
determining a set of text emotions from the set of text sentiment matches;
retrieving a set of text topical keywords and phrases; and,
comparing the set of text topical keywords and phrases to the set of text responses to generate a set of text topical matches.

13. The method of claim 8, wherein the step of compiling the set of combined sentiments further comprises the steps of:
ranking the set of combined responses;
filtering the set of combined responses;
determining a reward from the set of combined responses; and,
sending the reward to each user of the set of users.

14. A system for detecting a set of sentiments from a survey comprising:
a network;
a survey system connected to the network;
an administrator connected to the network;
a set of users connected to the network;
the survey system programmed carry out the steps of:
receiving a set of questions for the survey, a set of predetermined answers, a set of parameters, and a target list;
generating a survey message from the target list and the set of parameters;
sending the survey message to each user of the set of users;
sending the set of questions and the set of predetermined answers in response to the survey message;
receiving a set of audio responses to the set of questions;
receiving a set of text responses to the set of questions;
receiving a set of selected answers from the set of predetermined answers;
determining the set of sentiments from the set of audio responses, the set of text responses, and the set of selected answers; and,
compiling the set of sentiments.

15. The system of claim 14, wherein the survey system is further programmed to carry out the step of generating a report from the set of sentiments.

16. The system of claim 14, wherein the survey system is further programmed to carry out the steps of:
determining an audio quality from the set of audio responses;
determining a language from the set of audio responses;
determining a set of demographics from the set of audio responses;
determining a non-speech sentiment from the set of audio responses;
determining a set of slang phrases from the set of audio responses; and,
determining a speech sentiment from the set of audio responses.

17. The system of claim 16, wherein the survey system is further programmed to carry out the steps of:
retrieving a set of audio sentiment keywords and phrases;
comparing the set of audio responses to the set of audio sentiment keywords and phrases to generate a set of audio sentiment matches;
determining a set of audio emotions from the set of audio sentiment matches;
retrieving a set of audio topical keywords and phrases; and,
comparing to the set of audio topical keywords and phrases to the set of audio responses to generate a set of audio topical matches.

18. The system of claim 17, wherein the survey system is further programmed to carry out the steps of:
determining a set of text slang phrases from the set of text responses; and,
determining a set of text sentiments from set of text responses.

19. The system of claim 18, wherein the survey system is further programmed to carry out the steps of:
retrieving a set of text sentiment keywords and phrases;
comparing the set of text responses to the set of text sentiment keywords and phrases to generate a set of text sentiment matches;
determining a set of text emotions from the set of text sentiment matches;
retrieving a set of text topical keywords and phrases; and,
comparing the set of text topical keywords and phrases to the set of text responses to generate a set of text topical matches.

20. The system of claim 19, wherein the survey system is further programmed to carry out the steps of:
generating a set of combined responses from the set of audio sentiments, the set of text sentiments, and the set of selected answers;
ranking the set of combined responses;
filtering the set of combined responses;
determining a reward from the set of combined responses; and,
sending the reward to each user of the set of users.
